(19) United States
(12) Patent Application Publication
(10) Pub. No.: US 2025/0008605 A1
(43) Pub. Date: Jan. 2, 2025

(54) SYSTEM AND METHODS FOR SUPPORT OF EMERGENCY SERVICES USING INDIRECT COMMUNICATION PATH

(71) Applicant: ZTE CORPORATION, Shenzhen, Guangdong (CN)

(72) Inventors: Xingyue ZHOU, Shenzhen (CN); Hao DONG, Shenzhen (CN); Shuang LIANG, Shenzhen (CN)

(21) Appl. No.: 18/704,587

(22) PCT Filed: Feb. 28, 2022
(86) PCT No.: PCT/CN2022/078296

§ 371 Date: Apr. 25, 2024

(51) Int. Cl. H04W 76/50; H04W 48/16; H04W 88/04

(52) U.S. Cl. CPC H04W 76/50; H04W 48/16; H04W 88/04

(57) ABSTRACT

A wireless communication method including: transmitting, by a relay wireless communication terminal to a network, an initial emergency request to establish a Protocol Data Unit, PDU, session providing an emergency service for a remote wireless communication terminal according to a request for emergency services from the remote wireless communication terminal.

### CROSS REFERENCE TO RELATED APPLICATION(S)

This application is a national phase entry under 35 USC 371 of International Patent Application No. PCT/CN2022/078296 filed on Feb. 28, 2022, and claims priority to the International Patent Application, and the entire content of the International Patent Application is incorporated herein by reference.

### TECHNICAL FIELD

This document is directed generally to wireless communications, and in particular to 5^{th} generation (5G) communications.

### BACKGROUND

Proximity Services (ProSe) are services that can be provided by the Third Generation Partnership Project (3GPP) system based on (User Equipment) UEs being in proximity to each other.

### SUMMARY

One aspect of the present disclosure relates to a wireless communication method. In an embodiment, the wireless communication method comprising: transmitting, by a relay wireless communication terminal to a network, an initial emergency request to establish a Protocol Data Unit, PDU, session providing an emergency service for a remote wireless communication terminal according to a request for emergency services from the remote wireless communication terminal.

Another aspect of the present disclosure relates to a wireless communication method. In an embodiment, the wireless communication method comprising: transmitting, by a remote wireless communication terminal to a relay wireless communication terminal, a request for emergency services to allow the remote wireless communication terminal to establish a Protocol Data Unit, PDU, session providing an emergency service for the remote wireless communication terminal with a network.

Another aspect of the present disclosure relates to a communication device. In an embodiment, the communication device, comprising: a communication unit; and a processor configured to: transmit, to a network, an initial emergency request to establish a Protocol Data Unit, PDU, session providing an emergency service for a remote wireless communication terminal according to a request for emergency services from the remote wireless communication terminal.

Another aspect of the present disclosure relates to a communication device. In an embodiment, the communication device, comprising: a communication unit; and a processor configured to: transmit, to a relay wireless communication terminal, a request for emergency services to allow the communication device to establish a Protocol Data Unit, PDU, session providing an emergency service for the communication device with a network.

Various embodiments may preferably implement the following features:

In an embodiment, the relay wireless communication terminal transmits identity information of the remote wireless communication terminal to the network.

In an embodiment, the identity information comprises at least one of a Permanent Equipment Identifier, PEI, or a Medium Access Control, MAC, address of the remote wireless communication terminal.

In an embodiment, the relay wireless communication terminal transmits location information of the remote wireless communication terminal to the network in response to the relay wireless communication terminal having the location information of the remote wireless communication terminal.

In an embodiment, the location information of the remote wireless communication terminal comprises at least one of civic address information or geographic information.

In an embodiment, the relay wireless communication terminal transmits location information of the relay wireless communication terminal to the network in response to the relay wireless communication terminal not having the location information of the remote wireless communication terminal.

In an embodiment, the location information of the relay wireless communication terminal comprises at least one of a cell identifier, civic address information, or geographic information.

In an embodiment, the relay wireless communication terminal transmits a request to the remote wireless communication terminal for identity information of the remote wireless communication terminal.

In an embodiment, the relay wireless communication terminal receives an indication for an emergency service request from the remote wireless communication terminal.

In an embodiment, the relay wireless communication terminal transmits an emergency connectivity service information to the remote wireless communication terminal in response to the PDU session is successfully established.

In an embodiment, the emergency connectivity service information comprises at least one of: Proxy Call Session Control Function, P-CSCF, address information, local emergency numbers, region information where the local emergency numbers belong to.

In an embodiment, the region information comprises at least one of a Mobile Country Code, MCC, or public land mobile network, PLMN, information.

In an embodiment, the relay wireless communication terminal transmits information of provisioning of an emergency connectivity service to the remote wireless communication terminal via a relay discovery announcement message or relay discovery additional information.

In an embodiment, the relay wireless communication terminal receives information indicating the remote wireless communication terminal desiring an emergency connectivity service from the remote wireless communication terminal via a discovery solicitation message, and transmits information of provisioning of an emergency connectivity service to the remote wireless communication terminal via a relay discovery response message.

In an embodiment, the relay wireless communication terminal transmits to a policy control function, PCF, via an Access and Mobility Management Function, AMF, emergency service related information indicating the relay wireless communication terminal is able to provide emergency connectivity service when acting as a proximity service relay device.

In an embodiment, the relay wireless communication terminal receives from a PCF via an AMF, information of emergency connectivity service for the relay wireless communication terminal acting as a relay device.

The present disclosure relates to a computer program product comprising a computer-readable program medium code stored thereupon, the code, when executed by a processor, causing the processor to implement a wireless communication method recited in any one of foregoing methods.

The exemplary embodiments disclosed herein are directed to providing features that will become readily apparent by reference to the following description when taken in conjunction with the accompany drawings. In accordance with various embodiments, exemplary systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the exemplary embodiments and applications described and illustrated herein. Additionally, the specific order and/or hierarchy of steps in the methods disclosed herein are merely exemplary approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

The above and other aspects and their implementations are described in greater detail in the drawings, the descriptions, and the claims.

### BRIEF DESCRIPTION OF THE DRAWINGS

FIG. 1 shows the high-level view of the non-roaming 5G System architecture for Proximity-based Services (ProSe) according to an embodiment of the present disclosure.

FIG. 2 shows the 5G ProSe Layer-2 UE-to-Network Relay reference architecture according to an embodiment of the present disclosure.

FIG. 3 shows the high level reference architecture for a 5G ProSe Layer-3 UE-to-Network Relay according to an embodiment of the present disclosure.

FIG. 4 shows a schematic diagram of a wireless terminal according to an embodiment of the present disclosure.

FIG. 5 shows a schematic diagram of a wireless network node according to an embodiment of the present disclosure.

FIG. 6 shows a UE triggered a 5G ProSe Policy provisioning method according to an embodiment of the present disclosure.

FIG. 7 shows a method for a ProSe UE-to-Network Relay Discovery with Model A according to an embodiment of the present disclosure.

FIG. 8 shows a method for a ProSe UE-to-Network Relay Discovery with Model B according to an embodiment of the present disclosure.

FIG. 9 shows a wireless communication method according to an embodiment of the present disclosure.

### DETAILED DESCRIPTION

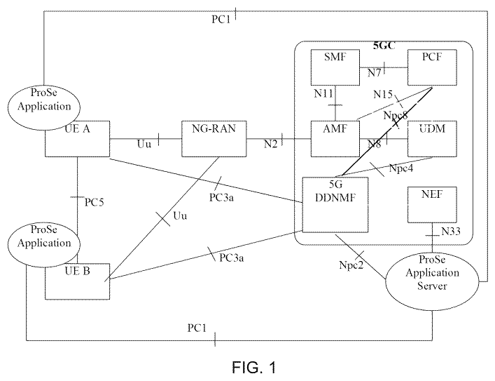

FIG. 1 shows the high-level view of the non-roaming 5G System architecture for Proximity-based Services (ProSe).

The 5GS enablers for ProSe include the following functions: 5G ProSe Direct Discovery; 5G ProSe Direct Communication; and 5G ProSe UE-to-Network Relay.

In more detail, for ProSe Direct Discovery, there are two models: Model A (“I am here”) and Model B (“who is there?”/“are you there?”).

The 5G ProSe Direct Communication over PC5 reference point is supported when the UE is “served by NR or E-UTRA” or when the UE is “not served by NR or E-UTRA”. A UE is authorized to perform ProSe Direct Communication when it has valid authorization and configuration. 5G ProSe Direct Communication supports both the cases of public safety and commercial service.

There are two mechanisms in 5G ProSe UE-to-Network Relay: 5G ProSe Layer-2 UE-to-Network Relay and 5G ProSe Layer-3 UE-to-Network Relay.

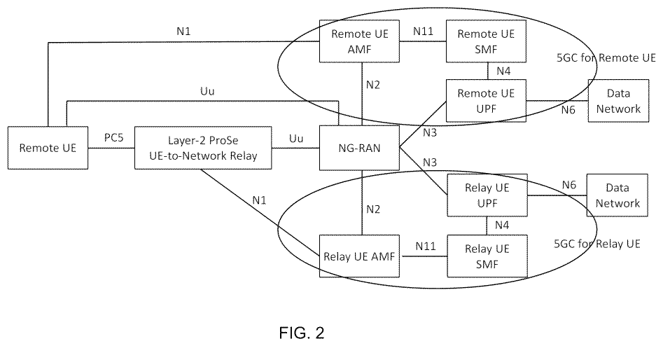

FIG. 2 shows the 5G ProSe Layer-2 UE-to-Network Relay reference architecture. The 5G ProSe Layer-2 Remote UE and 5G ProSe Layer-2 UE-to-Network Relay may be served by the same or different PLMNs. Uu is the interface between the 5G ProSe Layer-2 Remote UE and NG-RAN consists of RRC, SDAP and PDCP.

The 5G ProSe Layer-2 Remote UE and 5G ProSe Layer-2 UE-to-Network Relay are served by the same NG-RAN. The Core Network entities (e.g., AMF, SMF, UPF) serving the 5G ProSe Layer-2 Remote UE and the 5G ProSe Layer-2 UE-to-Network Relay can be the same or different.

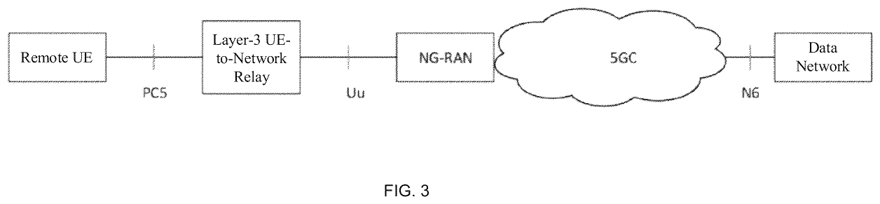

FIG. 3 shows the high level reference architecture for 5G ProSe Layer-3 UE-to-Network Relay. In FIG. 3, the 5G ProSe Layer-3 UE-to-Network Relay may be in the HPLMN or a VPLMN.

3GPP exemplarily defines the service description for emergency services in the IP Multimedia Core Network Subsystem (IMS), including the elements necessary to support IP Multimedia (IM) emergency services and IM emergency services for eCall.

Emergency services are independent from the IP-CAN with respect to the detection and routing of emergency sessions. The emergency services shall be possible over at least a cellular access network, a fixed broadband access, a nomadic access and a WLAN access to EPC or non-3GPP access to 5GC.

Emergency numbers and associated types received using a list are only used for detecting emergency calls in the same country. Emergency sessions should be prioritized over non-emergency sessions by the system.

Currently, it is not specified how the 5G ProSe remote UE obtains emergency services via 5G ProSe layer 3 UE-to-network relay in 3GPP.

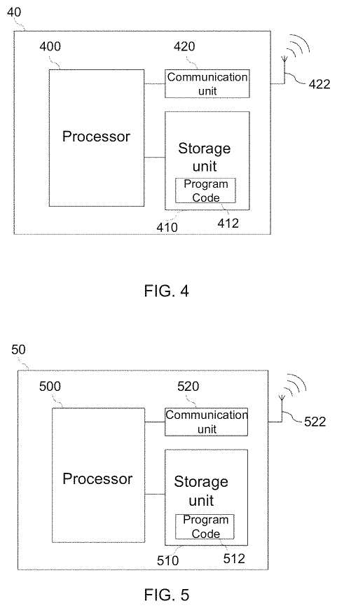

FIG. 4 relates to a schematic diagram of a wireless terminal 40 according to an embodiment of the present disclosure. The wireless terminal 40 may be a user equipment (UE), a mobile phone, a laptop, a tablet computer, an electronic book or a portable computer system and is not limited herein. The wireless terminal 40 may include a processor 400 such as a microprocessor or Application Specific Integrated Circuit (ASIC), a storage unit 410 and a communication unit 420. The storage unit 410 may be any data storage device that stores a program code 412, which is accessed and executed by the processor 400. Embodiments of the storage unit 410 include but are not limited to a subscriber identity module (SIM), read-only memory (ROM), flash memory, random-access memory (RAM), hard-disk, and optical data storage device. The communication unit 420 may a transceiver and is used to transmit and receive signals (e.g. messages or packets) according to processing results of the processor 400. In an embodiment, the communication unit 420 transmits and receives the signals via at least one antenna 422 shown in FIG. 4.

In an embodiment, the storage unit 410 and the program code 412 may be omitted and the processor 400 may include a storage unit with stored program code.

The processor 400 may implement any one of the steps in exemplified embodiments on the wireless terminal 40, e.g., by executing the program code 412.

The communication unit 420 may be a transceiver. The communication unit 420 may as an alternative or in addition be combining a transmitting unit and a receiving unit configured to transmit and to receive, respectively, signals to and from a wireless network node (e.g. a base station).

FIG. 5 relates to a schematic diagram of a wireless network node 50 according to an embodiment of the present disclosure. The wireless network node 50 may be a satellite, a base station (BS), a smart node, a network entity, a Mobility Management Entity (MME), Serving Gateway (S-GW), Packet Data Network (PDN) Gateway (P-GW), a radio access network (RAN) node, a next generation RAN (NG-RAN) node, a gNB, an eNB, a gNB central unit (gNB-CU), a gNB distributed unit (gNB-DU) a data network, a core network or a Radio Network Controller (RNC), and is not limited herein. In addition, the wireless network node 50 may comprise (perform) at least one network function such as an access and mobility management function (AMF), a session management function (SMF), a user plane function (UPF), a policy control function (PCF), an application function (AF), etc. The wireless network node 50 may include a processor 500 such as a microprocessor or ASIC, a storage unit 510 and a communication unit 520. The storage unit 510 may be any data storage device that stores a program code 512, which is accessed and executed by the processor 500. Examples of the storage unit 510 include but are not limited to a SIM, ROM, flash memory, RAM, hard-disk, and optical data storage device. The communication unit 520 may be a transceiver and is used to transmit and receive signals (e.g. messages or packets) according to processing results of the processor 500. In an example, the communication unit 520 transmits and receives the signals via at least one antenna 522 shown in FIG. 5.

In an embodiment, the storage unit 510 and the program code 512 may be omitted. The processor 200 may include a storage unit with stored program code.

The processor 500 may implement any steps described in exemplified embodiments on the wireless network node 50, e.g., via executing the program code 512.

The communication unit 520 may be a transceiver. The communication unit 520 may as an alternative or in addition be combining a transmitting unit and a receiving unit configured to transmit and to receive, respectively, signals to and from a wireless terminal (e.g. a user equipment or another wireless network node).

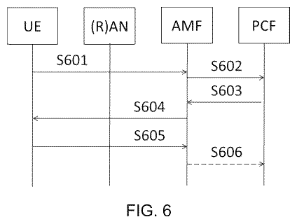

In an embodiment, there is provided a method for enabling that the UE is authorized by the network to provide emergency connectivity service when acting as a ProSe UE-to-Network Relay. FIG. 6 shows a UE triggered 5G ProSe Policy provisioning method according to an embodiment of the present disclosure. The method comprises the following steps:

Step S601: the UE sends the UE Policy provisioning request including the UE Policy Container (5G ProSe Policy Provisioning Request) to the AMF. In the 5G ProSe Policy Provisioning Request, the UE may include emergency service related information which indicates the UE is able to provide emergency connectivity service when acting as a ProSe UE-to-Network Relay.

Step S602: the AMF sends a Npcf_UEPolicyControl_Update request to the PCF including the UE Policy Container received from UE.

Step S603: the PCF decides the ProSe policy information to be provided to the UE and invokes Namf_Communication_N1N2MessageTransfer service operation provided by the AMF to deliver the ProSe policy information (in the UE Policy Container) to the UE. The ProSe policy information may contain the information regarding to emergency connectivity service when UE acting as a ProSe UE-to-Network Relay.

Step S604: the AMF delivers the UE Policy container (UE policy information) received from the PCF to the UE.

Step S605: the UE updates the UE policy provided by the PCF and sends the result to the AMF.

Step S606: if the AMF received the UE Policy container and the PCF subscribed to be notified of the reception of the UE Policy container then the AMF forwards the response of the UE to the PCF using Namf_Communication_N1MessageNotify.

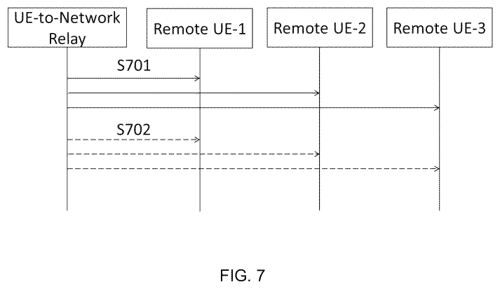

In an embodiment, there is provided a method where the UE acting as a ProSe UE-to-Network Relay announces the emergency service that can be offered during the ProSe UE-to-Network Relay Discovery with Model A procedure. FIG. 7 shows a method for ProSe UE-to-Network Relay Discovery with Model A according to an embodiment of the present disclosure. The method comprises the following steps:

Step S701: the UE acting as a ProSe UE-to-Network Relay sends a UE-to-Network Relay Discovery Announcement message. The UE-to-Network Relay Discovery Announcement message contains the Type of Discovery Message, Announcer Info and RSC, and is sent using the Source Layer-2 ID and Destination Layer-2 ID. The UE acting as a ProSe UE-to-Network Relay may also contain the information of provisioning of emergency connectivity service in the UE-to-Network Relay Discovery Announcement message.

Step S702: alternatively, the information of provisioning of emergency connectivity service may be included in the UE-to-Network Relay Discovery Additional Information messages by the UE acting as a ProSe UE-to-Network Relay.

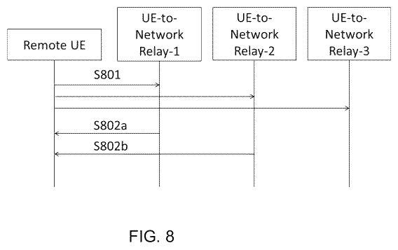

In an embodiment, there is provided a method where the UE acting as a ProSe UE-to-Network Relay responds to the remote UE with the information regarding to emergency service which offered during the ProSe UE-to-Network Relay Discovery with Model B procedure. FIG. 8 shows a method for ProSe UE-to-Network Relay Discovery with Model B according to an embodiment of the present disclosure.

Step S801: the remote UE sends a UE-to-Network Relay Discovery Solicitation message. The UE-to-Network Relay Discovery Solicitation message contains the Type of Discovery Message, Discoverer Info and RSC, and is send using the Source Layer-2 ID and Destination Layer-2 ID. If the remote UE wants to obtain emergency service via a ProSe UE-to-Network Relay, the remote UE may contain information which indicates that the remote UE desires emergency connectivity service in the UE-to-Network Relay Discovery Solicitation message.

Steps S802a and S802b: the ProSe UE-to-Network Relay-1 and Relay-2 that match the values contained in the solicitation message respond to the remote UE with a UE-to-Network Relay Discovery Response message. The UE-to-Network Relay Discovery Response message contains the information of provisioning of emergency connectivity service.

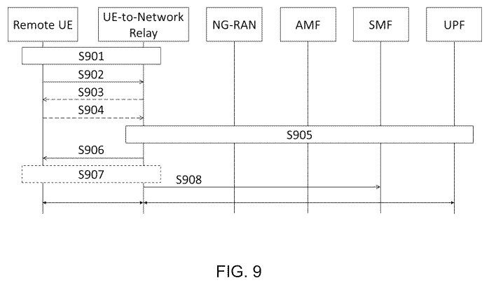

In an embodiment, there is provided a method for obtaining, by a remote UE, emergency connectivity services via UE-to-Network relay. FIG. 9 shows a method for ProSe Communication via ProSe Layer-3 UE-to-Network Relay in accordance with an embodiment of the present disclosure. The method comprises the following steps:

Step S901: the remote UE performs discovery of a ProSe UE-to-Network Relay. As part of the discovery procedure the remote UE learns about the emergency connectivity service that the ProSe UE-to-Network Relay provides (e.g. as described in the previous embodiments).

Step S902: the remote UE selects a UE-to-Network Relay and initiates a connection establishment for unicast mode communication by sending a ProSe Direct Link establishment request. If the remote UE wants to obtain emergency connectivity service, the remote UE contains an indication for emergency service request in the ProSe Direct Link establishment request.

Step S903: the UE acting as the ProSe UE-to-Network Relay verifies the emergency service request from the remote UE and may send a ProSe Direct Link identifier update request message to ask for remote UE's identity information, e.g. PEI, MAC address, etc.

Step S904: the remote UE sends a ProSe Direct Link identifier update accept message including its identity information as requested in the above step by the ProSe Direct Link identifier update request. The remote UE may also provide its location information (such as civic information, geographic information, etc.) via sending the ProSe Direct Link identifier update accept message. It is noted that steps S903 and S904 may take place during the PDU session establishment procedure (i.e. in the following step S905) as well.

Step S905: if there is no PDU session associated with the remote UE connectivity requirement (e.g. emergency connectivity service request) or a new PDU session for relaying is needed, the ProSe UE-to-Network Relay initiates a new PDU session establishment procedure for relaying before completing the PC5 connection establishment. The ProSe UE-to-Network Relay may establish this new PDU session with “initial emergency request”. The ProSe UE-to-Network Relay also provides the location information received from the remote UE to the network during this PDU session establishment procedure. If the remote UE does not provide its location information, the ProSe UE-to-Network Relay can provide its own location information (e.g. cell ID, civic information, geographic information, etc.) to the network. The network provides the P-CSCF address information (IP address/prefix, or FQDN), local emergency numbers, region information where the emergency numbers belong to (such as MCC code or PLMN information, other network identities) to the ProSe UE-to-Network Relay during the PDU session establishment procedure.

Step S906: once the PDU session is established, the ProSe UE-to-Network Relay responds the remote UE with ProSe Link establishment accept message. The ProSe UE-to-Network Relay contains the emergency connectivity service information for the remote UE in the ProSe Link establishment accept message. The emergency connectivity service information can include the P-CSCF address information (IP address/prefix, or FQDN), local emergency numbers, region information where the emergency numbers belong to (such as MCC code or PLMN information, other network identities), etc.

Step S907: the IPV6 prefix or IPv4 address (including NAT case) is allocated for the remote UE.

Step S908: the ProSe UE-to-Network Relay shall send a Remote UE Report message to the SMF for the PDU Session associated with the relay.

According to the various embodiments described herein, it is possible that, in the policy/parameter provisioning procedure, the UE indicates to the network with emergency service related information which indicates the UE is able to provide emergency connectivity service when acting as a ProSe UE-to-Network Relay. The network provides to the UE with the information regarding to emergency connectivity service for the UE that can act as a ProSe UE-to-Network Relay.

According to the various embodiments described herein, it is possible that, in the relay Discovery procedure, specifically during the UE-to-Network Relay Discovery procedure, the remote UE indicates that it desires emergency connectivity service in solicitation message. Further, the UE acting as a ProSe UE-to-Network Relay indicates the information of provisioning of emergency connectivity service for the remote UE.

According to the various embodiments described herein, it is possible that, in the PC5 link procedure, if the remote UE wants to obtain emergency connectivity service, the remote UE provides an indication for emergency service request to the ProSe UE-to-Network Relay via PC5 link message. The ProSe UE-to-Network Relay provides the emergency connectivity service information for the remote UE in the PC5 link message. The emergency connectivity service information can include the P-CSCF address information (IP address/prefix, or FQDN), local emergency numbers, region information where the emergency numbers belong to (such as MCC code or PLMN information, other network identities), etc. The UE acting as the ProSe UE-to-Network Relay sends a PC5 link message to the remote UE for remote UE's identity information, e.g. PEI, MAC address, etc. The remote UE includes its identity information as requested in the PC5 link message to the ProSe UE-to-Network Relay. The remote UE may also provide its location information (such as civic information, geographic information, etc.) in the PC5 link message to the ProSe UE-to-Network Relay.

According to the various embodiments described herein, it is possible that, in the PDU session procedure of the relay UE, the ProSe UE-to-Network Relay establishes a PDU session with “initial emergency request” for relay the emergency traffic. The ProSe UE-to-Network Relay provides the remote UE's location information if received from the remote UE to the network during this PDU session establishment procedure. If the remote UE does not provide its location information, the ProSe UE-to-Network Relay can provide its own location information (e.g. cell ID, civic information, geographic information, etc.) to the network. The network provides the P-CSCF address information (IP address/prefix, or FQDN), local emergency numbers, region information where the emergency numbers belong to (such as MCC code or PLMN information, other network identities) to the ProSe UE-to-Network Relay.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand exemplary features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any one of the above-described exemplary embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any one of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any one of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware, and any combination of these elements for performing the associated functions described herein. Additionally, for purpose of discussion, the various units are described as discrete units; however, as would be apparent to one of ordinary skill in the art, two or more units may be combined to form a single unit that performs the associated functions according embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of the claims. Thus, the disclosure is not intended to be limited to the implementations shown herein, but is to be accorded the widest scope consistent with the novel features and principles disclosed herein, as recited in the claims below.

1. A wireless communication method comprising:
transmitting, by a relay wireless communication terminal to a network, an initial emergency request to establish a Protocol Data Unit (PDU); session providing an emergency service for a remote wireless communication terminal according to a request for emergency services from the remote wireless communication terminal and
wherein the relay wireless communication terminal transmits information of provisioning of an emergency connectivity service to the remote wireless communication terminal via a relay discovery announcement message or relay discovery additional information; or
wherein the relay wireless communication terminal receives information indicating the remote wireless communication terminal desiring an emergency connectivity service from the remote wireless communication terminal via a discovery solicitation message, and transmits information of provisioning of an emergency connectivity service to the remote wireless communication terminal via a relay discovery response message.

2. The wireless communication method of claim 1, wherein the relay wireless communication terminal transmits identity information of the remote wireless communication terminal to the network; and
wherein the identity information comprises at least one of a Permanent Equipment Identifier (PEI) or a Medium Access Control (MAC) address of the remote wireless communication terminal.

3. (canceled)

4. The wireless communication method of claim 1, wherein the relay wireless communication terminal transmits location information of the remote wireless communication terminal to the network in response to the relay wireless communication terminal having the location information of the remote wireless communication terminal; and
wherein the location information of the remote wireless communication terminal comprises at least one of civic address information or geographic information.

5. (canceled)

6. The wireless communication method of claim 1, wherein the relay wireless communication terminal transmits location information of the relay wireless communication terminal to the network in response to the relay wireless communication terminal not having the location information of the remote wireless communication terminal; and
wherein the location information of the relay wireless communication terminal comprises at least one of a cell identifier, civic address information, or geographic information.

7. (canceled)

8. The wireless communication method of claim 1, wherein the relay wireless communication terminal transmits a request to the remote wireless communication terminal for identity information of the remote wireless communication terminal.

9. The wireless communication method of claim 1, wherein the relay wireless communication terminal receives an indication for an emergency service request from the remote wireless communication terminal.

10. The wireless communication method of claim 1, wherein the relay wireless communication terminal transmits an emergency connectivity service information to the remote wireless communication terminal in response to the PDU session is successfully established,
wherein the emergency connectivity service information comprises at least one of: Proxy Call Session Control Function (P-CSCF) address information, local emergency numbers, region information where the local emergency numbers belong to; and
wherein the region information comprises at least one of a Mobile Country Code (MCC) or public land mobile network (PLMN) information.

11-14. (canceled)

15. The wireless communication method of claim 1, wherein the relay wireless communication terminal transmits to a policy control function (PCF) via an Access and Mobility Management Function (AMF) emergency service related information indicating the relay wireless communication terminal is able to provide emergency connectivity service when acting as a proximity service relay device.

16. The wireless communication method of claim 1, wherein the relay wireless communication terminal receives from a PCF via an AMF, information of emergency connectivity service for the relay wireless communication terminal acting as a relay device.

17. A wireless communication method comprising: transmitting, by a remote wireless communication terminal to a relay wireless communication terminal, a request for emergency services to allow the remote wireless communication terminal to establish a Protocol Data Unit (PDU) session providing an emergency service for the remote wireless communication terminal with a network; and
wherein the relay wireless communication terminal transmits information of provisioning of an emergency connectivity service to the remote wireless communication terminal via a relay discovery announcement message or relay discovery additional information; or
wherein the relay wireless communication terminal receives information indicating the remote wireless communication terminal via a discovery solicitation message, and transmits information of provisioning of an emergency connectivity service to the remote wireless communication terminal via a relay discovery response message.

18. The wireless communication method of claim 17, wherein the relay wireless communication terminal transmits identity information of the remote wireless communication terminal to the network in response to the relay wireless communication terminal having the location information of the remote wireless communication terminal; and
wherein the identity information comprises at least one of a Permanent Equipment Identifier (PEI) or a Medium Access Control (MAC) address of the remote wireless communication terminal.

19. (canceled)

20. The wireless communication method of claim 17, wherein the relay wireless communication terminal transmits location information of the remote wireless communication terminal to the network in response to the relay wireless communication terminal having the location information of the remote wireless communication terminal; and
wherein the location information of the remote wireless communication terminal comprises at least one of civic address information or geographic information.

21. (canceled)

22. The wireless communication method of claim 17, wherein the relay wireless communication terminal transmits location information of the relay wireless communication terminal to the network in response to the relay wireless communication terminal not having the location information of the remote wireless communication terminal; and
wherein the location information of the relay wireless communication terminal comprises at least one of a cell identifier, civic address information, or geographic information.

23. (canceled)

24. The wireless communication method of claim 17, wherein the relay wireless communication terminal transmits a request to the remote wireless communication terminal for identity information of the remote wireless communication terminal.

25. The wireless communication method of claim 17, wherein the relay wireless communication terminal receives an indication for an emergency service request from the remote wireless communication terminal.

26. The wireless communication method of claim 17, wherein the relay wireless communication terminal transmits an emergency connectivity service information to the remote wireless communication terminal in response to the PDU session is successfully established;
wherein the emergency connectivity service information comprises at least one of: Proxy Call Session Control Function (P-CSCF) address information, local emergency numbers, region information where the local emergency numbers belong to; and
wherein the region information comprises at least one of a Mobile Country Code (MCC) or public land mobile network (PLMN) information.

27-30. (canceled)

31. The wireless communication method of claim 17, wherein the relay wireless communication terminal transmits to a policy control function (PCF) via an Access and Mobility Management Function (AMF) emergency service related information indicating the relay wireless communication terminal is able to provide emergency connectivity service when acting as a proximity service relay device.

32. The wireless communication method of claim 17, wherein the relay wireless communication terminal receives from a PCF via an AMF, information of emergency connectivity service for the relay wireless communication terminal acting as a relay device.

33. A communication device, comprising:
a communication unit; and
a processor configured to implement steps of:
transmitting, to a network, an initial emergency request to establish a Protocol Data Unit (PDU) session providing an emergency service for a remote wireless communication terminal according to a request for emergency services from the remote wireless communication terminal; and
wherein the communication device transmits information of provisioning of an emergency connectivity service to the remote wireless communication terminal via a relay discovery announcement message or relay discovery additional information; or
wherein the communication device receives information indicating the remote wireless communication terminal desiring an emergency connectivity service from the remote wireless communication terminal via a discovery solicitation message, and transmits information of provisioning of an emergency connectivity service to the remote wireless communication terminal via a relay discovery response message.

34-48. (canceled)

49. A communication device, comprising:
a communication unit; and
a processor configured to: perform the wireless communication method according to claim 17.

50-65. (canceled)
